(19) United States
(12) Patent Application Publication
(10) Pub. No.: US 2024/0368980 A1
(43) Pub. Date: Nov. 7, 2024

(54) Characterization of Reservoir Features and Fractures Using Artificial Intelligence

(71) Applicant: Saudi Arabian Oil Company, Dhahran (SA)

(72) Inventors: Abdulrahman Waleed Alrumaih, Dammam (SA); Mohamed Bouaouaja, Dhahran (SA); Essam M. Alyan, Dhahran (SA)

(21) Appl. No.: 18/312,242

(22) Filed: May 4, 2023

(51) Int. Cl. E21B 47/002; G06T 3/40; G06T 7/10; G06V 10/44; G06V 10/764; G06V 20/70

(52) U.S. Cl. CPC E21B 47/002; G06T 3/4053; G06T 7/10; G06V 10/44; G06V 10/764; G06V 20/70; G06T 2207/20081; G06T 2207/20084

(57) ABSTRACT

A computer-implemented method for characterization of reservoir features is described. The method includes extracting unseen images from a borehole image log. The method includes labeling a respective unseen image according to a reservoir feature present in the image using a computer vision model trained using images from a feature library. Additionally, the method includes interpreting the borehole image log according to the labeled images.

### TECHNICAL FIELD

This disclosure relates generally to characterization of reservoir features and fractures using artificial intelligence.

### BACKGROUND

Geological, geophysical and geo-mechanical characteristics of subsurface formations, such as reserviors, form the basis of drilling operations. Reservior features are characterized using tools that capture data associated with the reservior. The captured data can guide drilling operations.

### SUMMARY

An embodiment described herein provides a method for characterization of reservoir features and fractures using artificial intelligence. The method includes automatically recognizing and extracting, with one or more hardware processors, unseen images from a borehole image log. The method also includes automatically labeling, with the one or more hardware processors, a respective unseen image according to a reservoir feature present in the image using a computer vision model trained using images from a feature library. Additionally, the method includes automatically interpreting, with the one or more hardware processors, the borehole image log according to the labeled images.

An embodiment described herein provides an apparatus comprising a non-transitory, computer readable, storage medium that stores instructions that, when executed by at least one processor, cause the at least one processor to perform operations. The operations include automatically recognizing and extracting unseen images from a borehole image log, and automatically labeling a respective unseen image according to a reservoir feature present in the image using a computer vision model trained using images from a feature library. Additionally, the operations include automatically interpreting the borehole image log according to the labeled images.

An embodiment described herein provides a system. The system comprises one or more memory modules and one or more hardware processors communicably coupled to the one or more memory modules. The one or more hardware processors is configured to execute instructions stored on the one or more memory models to perform operations. The operations include automatically recognizing and extracting unseen images from a borehole image log, and automatically labeling a respective unseen image according to a reservoir feature present in the image using a computer vision model trained using images from a feature library. Additionally, the operations include automatically interpreting the borehole image log according to the labeled images.

In some embodiments, the computer vision model is trained using images stored in the feature library and obtained from published borehole image logs.

In some embodiments, the computer vision model is trained using images stored in the feature library and obtained from available field historical data.

In some embodiments, the images stored in the feature library and obtained from available field historical data are preprocessed.

In some embodiments, automatically recognizing and extracting unseen images from the borehole image log comprises preprocessing the images to increase a resolution of the images, resize the images, or increase a quality of the images.

In some embodiments, automatically interpreting the borehole image log according to the labeled images comprises characterization of subterranean features of the reservoir.

In some embodiments, the extracting, labeling, and interpreting occurs automatically, in real time, utilizing a memory gauge, or any combinations thereof.

In some embodiments, the computer vision model is a convolutional neural network (CNN) that obtains the images of the unseen well as input and outputs at least one reservoir feature detected in respective images.

In some embodiments, automatically labeling the respective unseen images using the trained computer vision model further comprises segmenting the borehole image log to extract the images, and classifying the segments of the borehole image log using a you only look once (YOLO) network.

### BRIEF DESCRIPTION OF DRAWINGS

FIG. 1 shows a feature library that includes images used to train, validate, or update a computer vision model

FIG. 2 shows a workflow for the characterization of reservoir features and fractures using artificial intelligence.

FIG. 3 is a workflow that shows automated feature picking.

FIG. 4 is a process flow diagram of a process for characterization of reservoir features.

FIG. 5 is a schematic illustration of an example controller (or control system) for characterization of reservoir features using artificial intelligence according to the present disclosure.

### DETAILED DESCRIPTION

Embodiments described herein enable characterization of reservoir features and fractures using artificial intelligence. In some embodiments, machine learning models, such as computer vision models, are trained to recognize patterns in borehole image logs that are captured in real-time during drilling activities or acquired through gauge recording post drilling. The training is executed using a feature library built from image logs. The images are automatically interpreted utilizing a framework described herein. In examples, the framework includes building a feature library, training at least one computer vision model using the feature library, and interpreting an image log using the trained model to output the reservoir features via automated feature picking. The framework characterizes reservoir features that are captured through borehole imaging tools according to features, especially fractures and fractures types. Instead of manually interpreting borehole images in a visual, manual review by geologists, the framework is based on a computer vision model that includes a Convolutional Neural Network (CNN) trained for real-time characterization of various subterranean features.

Borehole imaging tools create images of subterranean rock formations (e.g., reservoirs) and other geological features within a wellbore. The tools are lowered into the wellbore using a wireline or drill pipe. Data is captured using the tool, and imaging techniques are applied to the data to generate images of the wellbore structure. Borehole imaging tools include, for example, electrical imaging tools, acoustic imaging tools, optical imaging tools, magnetic imaging tools, nuclear imaging tools, and the like. The imaging tools capture respective properties that are mapped according to depth to form an image. The resulting images provide information describing the geological, geophysical and geo-mechanical characteristics of the rock, which is used to guide drilling operations. For example, drilling operations include casing programs, mud considerations, well control concerns, initial bit selections, offset well information, pore pressure estimations, economics, the identification of potential hydrocarbons in the reservoir, and other procedures that may be needed during the course of the well. In examples, the features present in the images guide drilling and completion operations, and are used to monitor the performance of producing wells. Drilling operations are subject to change if drilling conditions dictate. The features of the images can indicate changes in drilling conditions at varying depths. In some embodiments, the present techniques enable an evaluation of drilling operations during drilling and modifying the drilling operations responsive to the reservior features. Traditionally, the images are visually reviewed by geologists that interpret the formation and derive information from the images in a subjective, time consuming process. In embodiments, the framework described herein uses a CNN trained for real-time characterization of various reservoir features by recognizing patterns in the borehole images, including patterns undetectable by the human eye. The framework determines reservoir features in real time. Additionally, the CNN removes human subjectivity in determining features in borehole images.

In examples, the CNN is initialized and trained on image patterns of geological features for automated picking (e.g., classification) of the features and fractures. The CNN is an evolutive and adaptable by further periodic training and updates. Additionally, the feature library is enriched and tuned through training the picking or classification on a specific confined area of the respective images. For example, a specific confined area is a particular group of wells or a field. The feature library can be tuned and tailored to specialize in a specific field as a confined area to make more accurate classifications. The resultant model is able to interpret unseen acquired borehole images in automated manner. In examples, the automated interpretation (e.g., picking, classification) is executed in real-time on data transmitted while drilling with low resolution image quality. Additionally, in examples, the automated interpretation is executed on images that are low quality pictures, where the pictures are slightly different than the high quality data captured with a retrievable gauge with high resolution image quality.

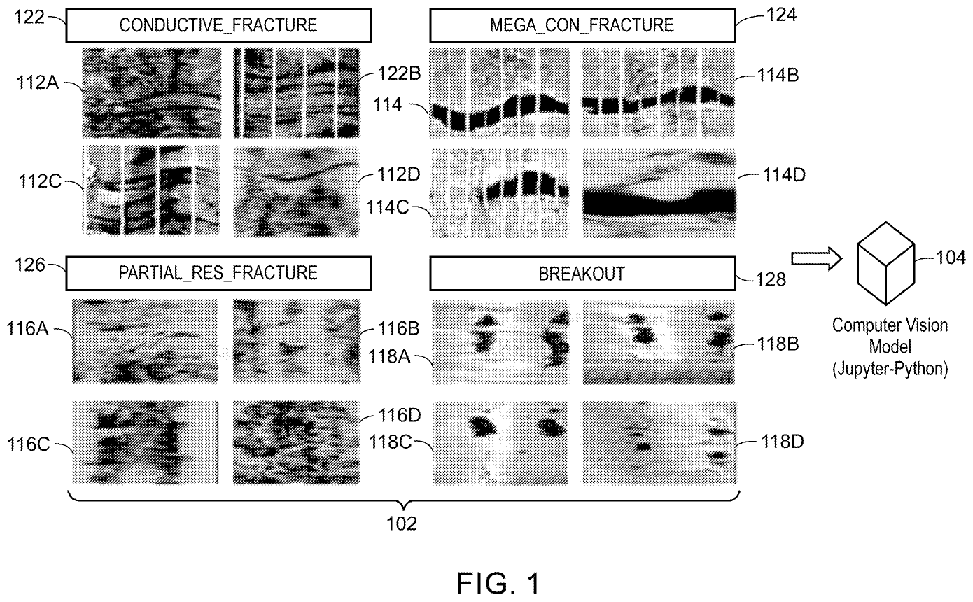

FIG. 1 shows a feature library 102 that includes images used to train, validate, or update a computer vision model 104. For ease of illustration, a particular number of images are shown associated with a respective label in the feature library 102. However, the feature library 102 can include any number of images and any number of labels. The computer vision model 104 is trained to output at least one label in response to an image obtained as input. The at least one label is a class of a respective image according to at least one reservoir feature. The class is determined based on, at least in part, a pattern in the image that is known to correspond to a reservoir feature. Accordingly, in some embodiments the class or classifications are reservoir features present in each image.

In some embodiments, the images in the feature library 102 are representative of the recognized reservoir features. In some embodiments, the feature library 102 is built by gathering hundreds of image logs, where the images are associated with at least one corresponding label (e.g., reservoir features). The feature library 102 is extensible, evolutive, and adaptable to enrich the reservoir features or the classes in these features. Additionally, in examples the label associated with an image can be based on a pattern detected in a confined area of the image. In some embodiments, the borehole image log is a recording of images across all the well length or depth, an image is cropped from the borehole image log and represents a limited length or depth of the well. The images are to represent at least one pattern such that each image correspond to a single reservoir feature. Accordingly, the borehole image log is composed of slices of images, and each image is interpreted to correspond to reservoir fracture feature.

In some embodiments, the computer vision model 104 is a convolutional neural network (CNN) that outputs a probability distribution over a set of predefined classes. The probability distribution includes a probability of one or more classes the CNN is trained to recognize being present in an image. In examples, the CNN outputs a vector of probabilities, where each element of the vector corresponds to a probability of a respective class the CNN is trained to recognize being present in an image.

The feature library 102 shows images 112A, 112B, 112C, and 112D associated with a conductive fracture class 122. The feature library 102 shows images 114A, 114B, 114C, and 114D associated with a mega conductive fracture class 124. The feature library 102 shows images 116A, 116B, 116C, and 116D associated with a partial resistive fracture class 126. The feature library 102 shows images 118A, 118B, 118C, and 118D associated with a breakout fracture class 128. Accordingly, in the example of FIG. 1, the images 112A-D, 114A-D, 116A-D, and 118A-D are labeled as showing reservoir features that indicate conductive fractures, mega conductive fractures, partial resistive fractures, and breakout fractures, respectively. For ease of description, particular reservoir features are described as classes shown in the feature library 102. However, the computer vision model 104 can recognize any reservoir feature reflected in borehole images. In some embodiments, the reservoir features associated with images in the feature library are based on geologist interpretations of the image logs. For example, one or more geologists manually review borehole images extracted from image logs. The one or more geologists reach a consensus on the reservoir features, such as fracture types, present in each respective image.

In some embodiments, reservoir features are the physical characteristics of the geological formation. The reservoir features guide the drilling operations used to extract hydrocarbons from the reservoir. The reservoir features include, for example, breakouts, bedding, fractures, vugs, caves, karst, faults, folds, concretions, inclusions, anticlines, synclines, and the like. In examples, breakouts are created when a borehole is drilled through a formation that is under in situ stress. As the borehole is drilled, the rock around the borehole experiences deformation, which can cause fractures to form. The fractures that form in the direction of least stress are known as breakouts. Bedding planes are the horizontal surfaces that separate successive layers of rock. In examples, bedding planes form patterns in borehole images that have a distinctive, flat appearance. Fractures are breaks in the rock that can increase the permeability of the reservoir. In some examples, fractures form patterns in borehole images that have dark, irregularly-shaped features. In examples, the dark, irregularly-shaped features cut across the bedding planes. In examples, the fracture types include conductive fractures, mega conductive fractures, partial resistive fracture, resistive fracture, and the like. In examples, resistive fractures are completely cemented fractures and do not offer any pathway to fluid flow. In examples, partial resistive fractures partially and cemented fractures and offer limited pathways to fluid flow which results in a limited recovery of hydrocarbons.

Vugs are cavities or small spaces found in rocks. Vugs are formed when gas is trapped in molten or semi-molten rock during a volcanic eruption or when sediment is deposited and then cemented together. In examples, vugs form patterns in borehole images that are dark trapped bubbles in the rock. Caves are voids are cavities within the rock formations. In examples, caves form patterns in borehole images that are spaces containing hydrocarbons. Karst are distinctive landforms that are created by the dissolution of soluble rocks, such as limestone, dolomite, and gypsum. In examples, karst form patterns that that indicate the type of rock and the presence of fluid based on the specific imaging techniques used.

Faults are fractures in the rock that have experienced movement along one or both sides. In examples, faults form patters in borehole images that are abrupt changes in the orientation of the bedding planes. Folds are reservoir features in which the rock layers have been bent or folded. In examples, folds form patterns in the borehole images as curved or undulating bedding planes. Concretions are rounded, isolated masses of mineral that form within sedimentary rock. In examples, concretions form patters in borehole images as spherical or oval-shaped features that stand out from the surrounding rock. Inclusions are fragments of rock that are enclosed within another rock. In examples, inclusions form patters in borehole images as irregularly-shaped features that are darker than the surrounding rock. Anticlines are folds in the rock layers that cause the formation to bulge upward, while synclines are folds that cause the formation to sink downward. In examples, anticlines form patterns in the borehole images as bedding planes inclined away from the folds. In examples, synclines form patterns in the borehole images as bedding planes inclined toward the folds.

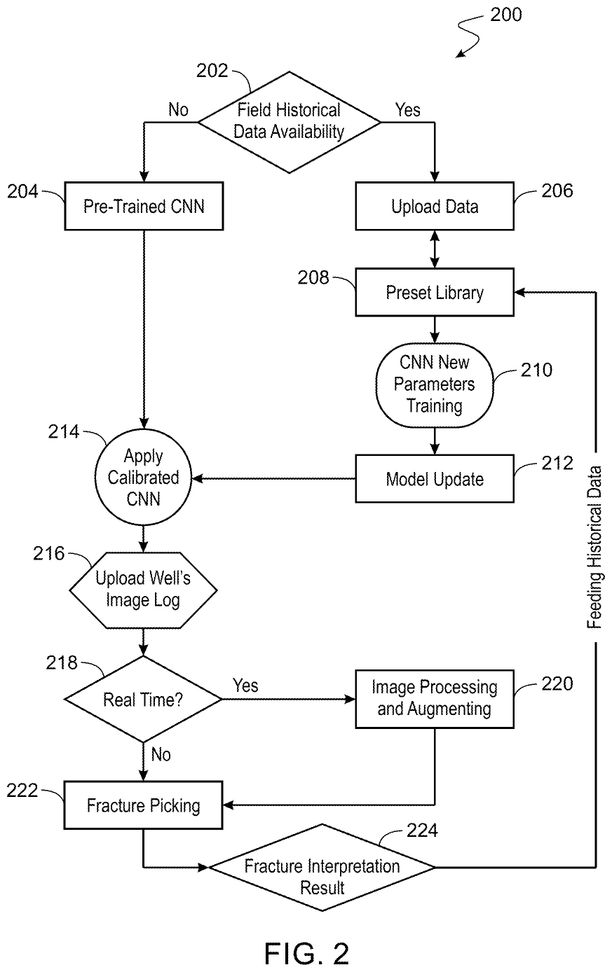

FIG. 2 shows a workflow 200 for the characterization of reservoir features and fractures using artificial intelligence. In examples, the CNN is the computer vision model 104 in FIG. 1. The CNN is initialized and trained on image patterns associated with geological features for automated picking of the features and fractures. The CNN is evolutive and adaptable by continuous training and updates using images from the feature library.

At block 202, it is determined if historical data associated with a field is available. In examples, image logs of one or more unseen wells are to be classified according to reservoir features present in the image. If historical data associated with the field including unseen image logs is not available, the workflow 200 continues to block 204. If historical data associated with the field including unseen image logs is available, the workflow 200 continues to block 206.

At block 204, a pre-trained CNN is selected to interpret input images from the field. In examples, the pre-trained CNN is trained using an initial feature library trained on images from various labeled borehole images, not limited to a geological area. The training data set extracted from this initial feature library is used to build a pre-trained CNN. Accordingly, in some embodiments the pre-trained CNN is trained using on the preset features in an initial feature library.

At block 206, field historical data is uploaded to a present library (e.g., feature library) at block 208. Training images that correspond to the available field historical data are added to the feature library at block 208. In some embodiments, borehole images are selected from library items relevant to the selected geological area. The borehole images are imported from previously recorded wells from the field corresponding to the unseen wells.

In some embodiments, images are extracted from image logs in the field historical data. To extract images from image logs, image contrast variation with depth is defined to segment the image log through the borehole. In examples, the resistivity contrast of the image log is used to segment the pictures where the segmentation would result in a series of pictures. The segmentation of the image log results in a series of images. The images can show depth intervals, time intervals, or any combinations thereof.

In some embodiments, the images are preprocessed. For example, the pictures are resized, the resolution of the pictures is enhanced, the quality of the pictures is augmented, or any combinations thereof. Resizing images extracted from the image log to a predetermined input size includes cropping the images. Enhancing the resolution of the image can include, for example upscaling the resolution of the images. In examples, augmenting the picture quality ensures that reservoir features are visible in the images. Augmenting the picture quality includes adjusting the brightness of the images. In examples, the images are augmented using multiple settings, such as different shades, brightness, angles, and any combinations thereof, to increase the quality of the images. Shades and brightness refer to the levels of lighting present in the images. The angle refers to an angle of view with respect to a feature. In embodiments, the reservoir features in the images are representative of that feature in different settings. The computer vision models trained using images with different levels of lighting and angles enables the detection of reservoir features using images with low quality.

At block 210, uploaded data is used for CNN new parameters training. In the CNN new parameters training, the model is updated to accommodate and account for the few tweaks in the updated preset Library, after which, the model is updated. In some embodiments, the historical dataset is sliced into training, validating and blind tests components. The convolutional neural network is trained using the training dataset. In some embodiments, the trained CNN is trained using images of a predefined geological area, and the trained CNN is executed on image logs from unseen wells in or near the predefined geological area.

The CNN is validated using a validation dataset. The CNN is tested using a testing dataset. For example, the pretrained convolutional neural network trained using preset library items is used to the imagery from the field historical data. In some embodiments, the trained and validated model is compiled.

At block 212, the computer vision model is updated. In examples, the model is updated after accounting for the new set of pictures used for training in the previous steps when fresh data was uploaded. The model is updated using the selected training images.

At block 214, the trained calibrated CNN is selected. The calibrated CNN is the updated model generated at block 212. At block 216, an unseen image log (e.g., unlabeled images of one or more unseen wells to be classified the trained CNN) is obtained. At block 218, it is determined if the image log is being captured in real time. If the image log is not being captured in real time, the workflow 200 continues to block 222. If the image log is being captured in real time, the workflow 200 continues to block 220.

At block 220, an image preprocessing is executed on the image log captured in real time. In some embodiments, preprocessing the images includes resizing the images extracted from the image log, enhancing the resolution of the images extracted from the image log, augmenting the quality of the images extracted from the image log, or any combinations thereof. In some embodiments, real-time image logs are segmented and preprocessed for input to the trained computer vision model. In examples, the real-time image logs are poor quality. To optimize the flow of data, the segmented images are preprocessed to increase the image quality for a more robust, accurate interpretation.

After the image processing at block 220, the workflow 200 continues to block 222. At block 222, automated feature picking is performed. Unseen images extracted from the unseen image logs are input to the trained CNN. The output of the trained CNN is interpreted at block 224. The interpretation is the final classification of the feature whether it is a fracture, bedding, and the like. For example, probability distributions of one or more classes present in respective images is output by the trained CNN. In an example, the class with the highest probability of being present in a respective image is selected as the label associated with the image. The images and corresponding labels are input to the feature library for further training of the CNN and model updates.

In examples, fracture picking is performed, wherein the input images (either real-time augmented or from logs in memory) are applied to the respective trained CNN. If field historical data is available, the respective trained CNN is tuned to a particular geological area. The output of the respective trained CNN is a fracture interpretation result. In examples, the fracture interpretation result includes the features and specially fractures and fracture types. In some embodiments, the reservoir features are input/feedback to the preset/feature library. In examples, automated feature picking categorizes the segmented images by comparing them to the images stored in the feature library. Shapes in the images are recognized as reservoir features, cropped from the image log as an individual image/picture, and labeled with the recognized reservoir features. The recognized shapes are iteratively recognized in the images, cropped from the image, labeled, and stored in the feature library as a recognized shape.

In examples, the labeled images generated from the unseen image logs are used to inform drilling operations, including fracture analysis. For example, the orientation, spacing, and intensity of the fractures are analyzed to determine their impact on fluid flow within the reservoir. The labeled images can also be used in structural analysis. For example, the structure of the formation is analyzed by identifying faults and folds, as well as the orientation of the bedding planes. This information can be used to understand the geologic history of the formation.

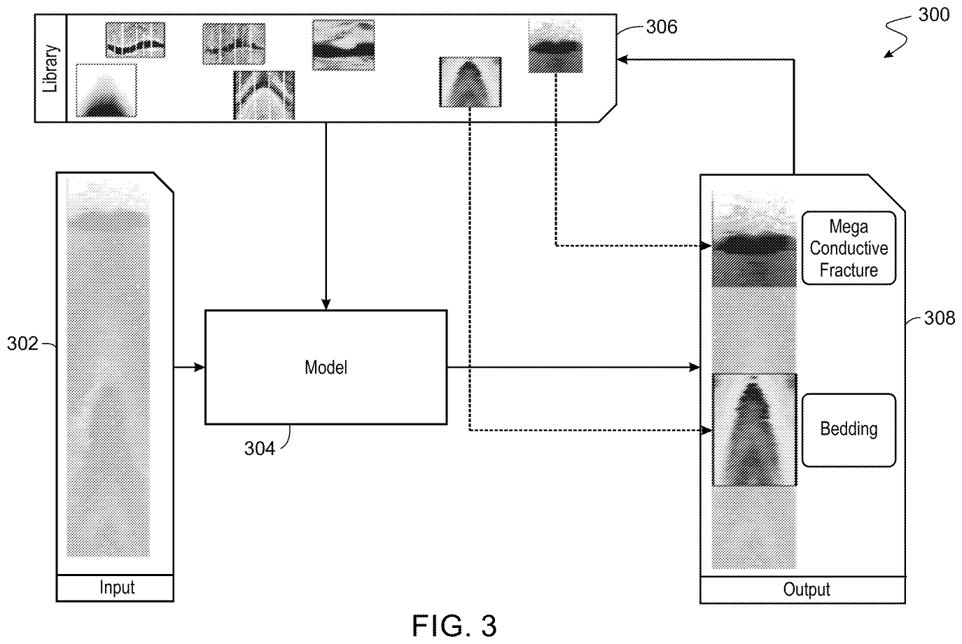

FIG. 3 is a workflow that shows automated feature picking. The automated feature picking may be, for example, the automated feature picking described at block 222 of FIG. 2. Feature picking refers to the output of “the features and specially fractures and fracture types.”

Input images are shown at block 302. The input images are unseen images, not previously input to the trained CNN of the computer vision model at block 304. In some embodiments, the input images are memory recorded borehole images. Preprocessing is performed to ensure compatibility with the model. In this example, the borehole image logs are imported from memory and images are segmented from the image logs. In some embodiments, the images are obtained from an image log received in real time. For example, the image track is loaded, and real time images are extracted. The image track includes a sequence of images recorded along a depth interval of a borehole. Image preprocessing is performed on the images extracted from the real time borehole. Preprocessing the images includes resizing the images extracted from the image log, enhancing the resolution of the images extracted from the image log, augmenting the quality of the images extracted from the image log, or any combinations thereof.

At block 304, a computer vision model including a trained CNN obtains the input images at block 302. The CNN is trained using images stored in the feature library at block 306. The CNN classifies reservoir features in the input images at block 302. Accordingly, in some embodiments the trained, tested, and validated CNN is applied to the unseen borehole images. The output 308 of the computer vision model 304 includes reservoir features associated with respective input images. In some embodiments, the output of the trained CNN is labels representing reservoir features associated with respective input images. The images and respective labels output by the model 304 are stored in the feature library at block 306. In some embodiments, the CNN is iteratively trained using the interpreted images stored in the feature library.

The present techniques automatically select the reservoir features present in respective borehole images using artificial intelligence. In this manner, man hours are reduced, and geologists do not visually examine the image logs to mark the locations and interpretations of the geological features. The subjectivity of human interpretation of image logs is eliminated, resulting in a more accurate determination of reservoir features in borehole image logs. In embodiments, the automation of the interpreting the borehole image logs enables real time identification of reservoir features in an unseen well. The real time identification is used to guide well path planning and geostreeing. In some embodiments, real-time refers to a determination of reservoir features within a time interval that is fast enough to impact the well at or near the time of image log capture.

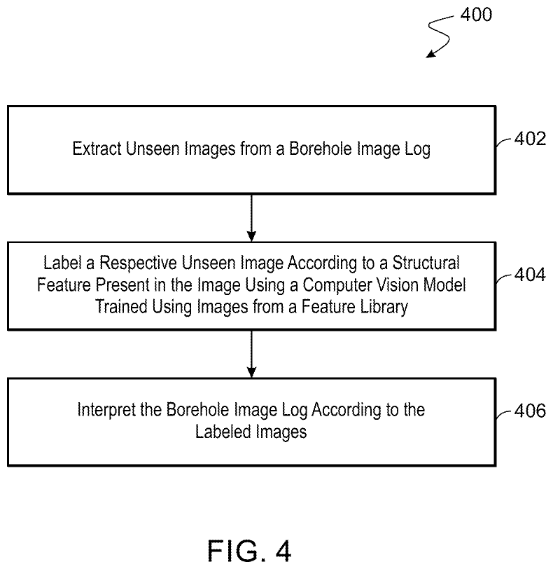

FIG. 4 is a process flow diagram of a process 400 for characterization of reservoir features. In some embodiments, the computer vision models are trained as described with respect to FIG. 2. The present techniques introduce a systematic and automated procedure to assess the reservoir features.

At block 402, unseen images are extracted from a borehole image log. In some embodiments, when a new, unseen well is drilled borehole image logs are recorded. In some embodiments, the extracted unseen images are preprocessed. For example, the images are preprocessed to increase a resolution of the images or resize the images.

At block 404, a respective unseen image is labeled according to a reservoir feature present in the image using a computer vision model. The computer vision model is trained using images from a feature library. In some embodiments, the computer vision model is a CNN, a you only look once (YOLO) network, or a Jupyter-Python model. In some embodiments, the computer vision model is trained using images stored in the feature library and obtained from published borehole image logs. In some embodiments, the computer vision model is trained using images stored in the feature library and obtained from available field historical data. In some embodiments, the images stored in the feature library and obtained from available field historical data are preprocessed, wherein the images are resized (e.g., cropped to a predetermined size) or a resolution of the images is increased.

At block 406, the borehole image log is interpreted according to the labeled images. In some embodiments, interpreting the borehole image log according to the labeled images comprises characterizing subterranean features of the reservoir. In some embodiments, the extracting, labeling, and interpreting occurs automatically, in real time, utilizing a memory gauge, or any combinations thereof. In examples, a memory gauge is an electronic gauge that samples and records data such as the image logs, extracted images, labeled images, and the like.

The systems and techniques described herein are an evolutive adaptable application that enables a user to build a library of reservoir features specific to a known, predetermined field. In some embodiments, the labeled images and interpreted borehole image log is used, in real time, to guide well paths and geo steering through the provision of proactive insight to the wells based on the reservoir features.

In examples, the labeled images are integrated with other data. For example, the borehole image log interpretation is integrated with other geological and geophysical data to create a comprehensive understanding of the subsurface. This can help to identify potential reservoirs, determine drilling locations, and optimize production. For example, the labeled images are integrated with other logs to determine information on the petrophysical properties of the rock, such as density, porosity, and permeability. This information is analyzed to determine the suitability of the rock as a reservoir at various depths. The labeled images can also be used with other logs to identify different lithologies present in the formation. This information is used to understand the depositional environment and geologic history of the formation.

Some advantages of the present techniques includes high quality objective fracture log interpretation. Human intervention is reduced or eliminated in the interpretation of borehole image logs. For example, subjectivity of interpretations in case of heavy fracture occurrences is reduced, and debatable fracture class and types (e.g., features where human interpreters disagree on the interpretation) are reduced. The present techniques also reduce the time needed for interpretation. The real time interpretation according to the present techniques can be used by reservoir management engineers to complete tasks, thereby reducing the time spent on the tasks. Further, the present techniques enable optimized well path and well placement with lower costs in development and higher value due to increased accuracy.

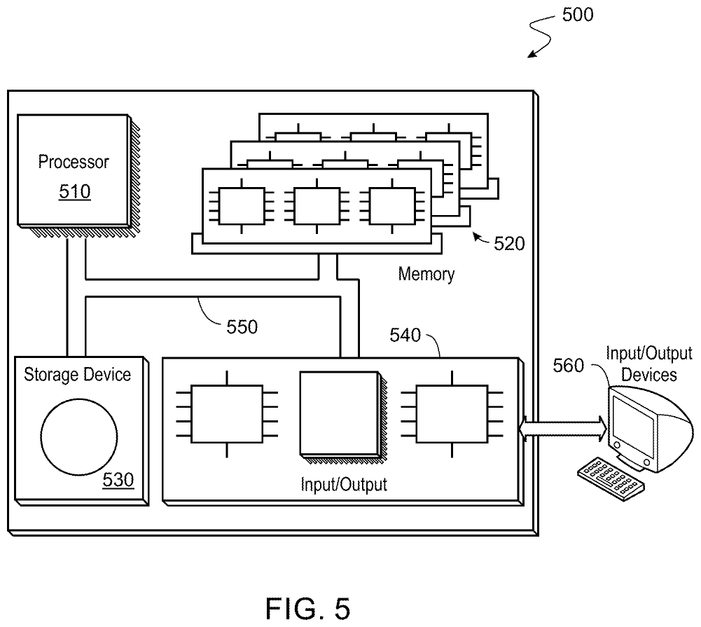

FIG. 5 is a schematic illustration of an example controller 500 (or control system) for characterization of reservoir features using artificial intelligence according to the present disclosure. For example, the controller 500 may be operable using the feature library 100 of FIG. 1 according to the workflow 200 of FIG. 2, the workflow 300 of FIG. 3, or the process 400 of FIG. 4. The controller 500 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 500 includes a processor 510, a memory 520, a storage device 530, and an input/output interface 540 communicatively coupled with input/output devices 560 (for example, displays, keyboards, measurement devices, sensors, valves, pumps). Each of the components 510, 520, 530, and 540 are interconnected using a system bus 550. The processor 510 is capable of processing instructions for execution within the controller 500. The processor may be designed using any of a number of architectures. For example, the processor 510 may be a CISC (Complex Instruction Set Computers) processor, a RISC (Reduced Instruction Set Computer) processor, or a MISC (Minimal Instruction Set Computer) processor.

In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output interface 540.

The memory 520 stores information within the controller 500. In one implementation, the memory 520 is a computer-readable medium. In one implementation, the memory 520 is a volatile memory unit. In another implementation, the memory 520 is a nonvolatile memory unit.

The storage device 530 is capable of providing mass storage for the controller 500. In one implementation, the storage device 530 is a computer-readable medium. In various different implementations, the storage device 530 may be a floppy disk device, a hard disk device, an optical disk device, or a tape device.

The input/output interface 540 provides input/output operations for the controller 500. In one implementation, the input/output devices 560 includes a keyboard and/or pointing device. In another implementation, the input/output devices 560 includes a display unit for displaying graphical user interfaces.

There can be any number of controllers 500 associated with, or external to, a computer system containing controller 500, with each controller 500 communicating over a network. Further, the terms “client,” “user,” and other appropriate terminology can be used interchangeably, as appropriate, without departing from the scope of the present disclosure. Moreover, the present disclosure contemplates that many users can use one controller 500 and one user can use multiple controllers 500.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware-or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a key board and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example. some processes depicted in the accompanying figures do not necessarily require the particular order shown. or sequential order, to achieve desirable results.

What is claimed is:

1. A computer-implemented method for characterization of reservoir features, the method comprising:
extracting, with one or more hardware processors, unseen images from a borehole image log;
labeling, with the one or more hardware processors, a respective unseen image according to a reservoir feature present in the image using a computer vision model trained using images from a feature library; and
interpreting, with the one or more hardware processors, the borehole image log according to the labeled images.

2. The computer implemented method of claim 1, wherein the computer vision model is trained using images stored in the feature library and obtained from published borehole image logs.

3. The computer implemented method of claim 1, wherein the computer vision model is trained using images stored in the feature library and obtained from available field historical data.

4. The computer implemented method of claim 3, wherein the images stored in the feature library and obtained from available field historical data are preprocessed.

5. The computer implemented method of claim 1, wherein extracting unseen images from the borehole image log comprises preprocessing the images to increase a resolution of the images, resize the images, or increase a quality of the images.

6. The computer implemented method of claim 1, wherein interpreting the borehole image log according to the labeled images comprises characterization of subterranean features of the reservoir.

7. The computer implemented method of claim 1, wherein the extracting, labeling, and interpreting occurs in real time or utilizing a memory gauge.

8. The computer implemented method of claim 1, wherein the computer vision model is a convolutional neural network (CNN) that obtains the images of the unseen well as input and outputs at least one reservoir feature detected in respective images.

9. The computer implemented method of claim 1, wherein labeling the respective unseen images using the trained computer vision model further comprises:
segmenting the borehole image log to extract the images; and
classifying the segments of the borehole image log using a you only look once (YOLO) network.

10. An apparatus comprising a non-transitory, computer readable, storage medium that stores instructions that, when executed by at least one processor, cause the at least one processor to perform operations comprising:
extracting unseen images from a borehole image log;
labeling a respective unseen image according to a reservoir feature present in the image using a computer vision model trained using images from a feature library; and
interpreting the borehole image log according to the labeled images.

11. The apparatus of claim 10, wherein the computer vision model is trained using images stored in the feature library and obtained from published borehole image logs.

12. The apparatus of claim 10, wherein the computer vision model is trained using images stored in the feature library and obtained from available field historical data.

13. The apparatus of claim 12, wherein the images stored in the feature library and obtained from available field historical data are preprocessed.

14. The apparatus of claim 10, wherein extracting unseen images from the borehole image log comprises preprocessing the images to increase a resolution of the images, resize the images, or increase a quality of the images.

15. A system, comprising:
one or more memory modules;
one or more hardware processors communicably coupled to the one or more memory modules, the one or more hardware processors configured to execute instructions stored on the one or more memory models to perform operations comprising:
extracting unseen images from a borehole image log;
labeling a respective unseen image according to a reservoir feature present in the image using a computer vision model trained using images from a feature library; and
interpreting the borehole image log according to the labeled images.

16. The system of claim 15, wherein the computer vision model is trained using images stored in the feature library and obtained from published borehole image logs.

17. The system of claim 15, wherein interpreting the borehole image log according to the labeled images comprises characterization of subterranean features of the reservoir.

18. The system of claim 15, wherein the extracting, labeling, and interpreting occurs in real time or utilizing a memory gauge.

19. The system of claim 15, wherein the computer vision model is a convolutional neural network (CNN) that obtains the images of the unseen well as input and outputs at least one reservoir feature detected in respective images.

20. The system of claim 15, wherein labeling the respective unseen images using the trained computer vision model further comprises:
segmenting the borehole image log to extract the images; and
classifying the segments of the borehole image log using a you only look once (YOLO) network.
